(19) United States
(12) Patent Application Publication
(10) Pub. No.: US 2020/0357206 A1
(43) Pub. Date: Nov. 12, 2020

(54) METHOD AND SYSTEM FOR ACCESS CONTROL OF A FIRE PANEL

(71) Applicant: JOHNSON CONTROLS FIRE PROTECTION LP, Boca Raton, FL (US)

(72) Inventors: Liem-Binh TRAN, Saint-Hubert (CA); Jérome COURNOYER, Chambly (CA); Sylvain LEMIEUX, Brossard (CA); Kim BOUCHARD, Montreal (CA)

(21) Appl. No.: 16/406,815

(22) Filed: May 8, 2019

(51) Int. Cl. G07C 9/00; H04L 29/06

(52) U.S. Cl. CPC G07C 9/00039; H04L 63/083

(57) ABSTRACT

Aspects of the present disclosure include methods, apparatus, and computer readable medium for receiving, from an access control device associated with an access controlled asset, an indication that a requester is requesting access to the access controlled asset, verifying whether the requester is authorized to access the access controlled asset, transmitting, in response to verifying that the requester is authorized to access the access controlled asset, an access code to a handheld device of the requester, and wherein the access control device grants the requester access to the access controlled asset in response to receiving the access code input by the requester.

### BACKGROUND

Certain access controlled assets (e.g., fire panel) may require servicing, maintenance, or other forms of access (e.g., firefighters may need to access a fire panel after a fire alarm has activated to disable the fire alarm). Currently, access to privileged operations of a fire panel is controlled through the use of a fixed access code which is configured and stored in the fire panel configuration. The access code is tied to a specific access level for a specific panel but is not tied to specific individual. Authorized personnel will share the same access code and is often written locally inside the panel for convenience. However, the methods described above may cause security vulnerability because the access code may be misplaced or stolen, and used for unauthorized access. Additionally, if access is withdrawn from the person who still knows the access code, the person may still have access to the assets. Changing an access code to revoke privileged operations of unauthorized personnel due to employee's departure can only be done by changing the fire panel configuration which requires a set amount of functional test to be performed as required by fire regulation. This requirement will discourage building owners from changing the access code and thus defeat the purpose of securing the asset. Therefore, improvements in protecting assets, such as a fire panel, as well as improving the process of revoking the access code may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

An aspect of the present disclosure includes a method for authenticating an access request including receiving, from an access control device associated with an access controlled asset, an indication that a requester is requesting access to the access controlled asset, verifying whether the requester is authorized to access the access controlled asset, transmitting, in response to verifying that the requester is authorized to access the access controlled asset, an access code to a handheld device of the requester, and wherein the access control device grants the requester access to the access controlled asset in response to receiving the access code input by the requester.

Some aspects of the present disclosure includes a server for authenticating an access request including a memory and a processor configured to perform the steps of receiving, from an access control device associated with an access controlled asset, an indication that a requester is requesting access to the access controlled asset, verifying whether the requester is authorized to access the access controlled asset, transmitting, in response to verifying that the requester is authorized to access the access controlled asset, an access code to a handheld device of the requester, and wherein the access control device grants the requester access to the access controlled asset in response to receiving the access code input by the requester.

Certain aspects of the present disclosure includes a non-transitory computer readable medium having instructions stored therein that, when executed by one or more processors of a controller, cause the one or more processors to perform the steps of receiving, from an access control device associated with an access controlled asset, an indication that a requester is requesting access to the access controlled asset, verifying whether the requester is authorized to access the access controlled asset, transmitting, in response to verifying that the requester is authorized to access the access controlled asset, an access code to a handheld device of the requester, and wherein the access control device grants the requester access to the access controlled asset in response to receiving the access code input by the requester

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for authenticating an access request in accordance with aspects of the present disclosure;

FIG. 2 illustrates an example of a method for authenticating an access request in accordance with aspects of the present disclosure;

FIG. 3 illustrates an example of a computer system in accordance with aspects of the present disclosure; and

FIG. 4 illustrates a block diagram of various exemplary system components in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected”, is one in which signals, physical communications, and/or logical communications can be sent and/or received. An operable connection can include a physical interface, a data interface and/or an electrical interface.

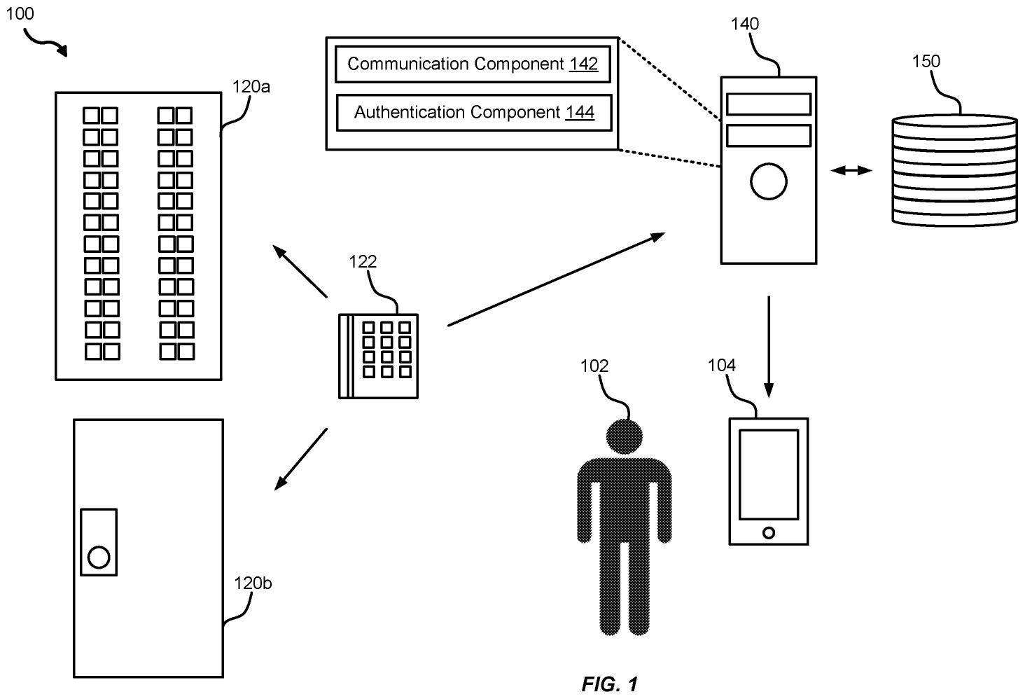

Turning now to FIG. 1, an environment 100 for authenticating an access request may include a requester 102 attempting to gain access to one or more access controlled assets 120. The requester 102 may be a technician attempting to service, maintain, and/or repair the one or more access controlled assets 120. The requester 102 may be a building supervisor or a firefighter attempting to access a fire panel. The environment 100 may include a handheld device 104. The handheld device 104 may include a wireless device, a mobile phone, a cellular phone, a tablet computer, a personal digital assistant, a smartphone, or other portable devices capable of wireless communications. The one or more access controlled assets may include one or more of a fire panel 120a, a secured door 120b for accessing a room (not shown) housing the fire panel 120a, or any physical or electrical obstruction that prevents unauthorized users from accessing the fire panel 120a and/or the secured door 120b. The environment 100 may include an access control device 122. The access control device 122 may include one or more of a keypad, a RFID reader, a magnetic card reader, an electronic lock, for example. In some implementations, the access control device 12 may electronically (e.g., disable the input/output mechanism of the fire panel 120a) or physically (e.g., locking the secured door 120b) prevent the requester 102 from accessing the one or more access controlled assets 120.

Still referring to FIG. 1, the environment 100 may include an authentication server 140 communicatively coupled with an optional data repository 150. The authentication server 140 may include a communication component 142 configured to receive access requests and/or transmit access codes. The authentication component 144 may be configured to authenticate the request based on the identity of the requester 102. The authentication server 140 may be remote from the building housing the fire panel 120a and the secured door 120b. The optional data repository 150 may be configured to store information such as assets, access privileges, and access logs.

In some implementations, during operations, the requester 102 may attempt to access the one or more access controlled assets 120 by providing initial authentication information. For example, the requester 102 may provide a PIN or a password, or utilize an authorization device, such as a RFID, an electronic key, or an ID card, to transmit the initial authentication information embedded in the RFID, the electronic key, or the ID card. For example, the requester 102 may input the PIN or the password using the access control device 122. Alternatively, the requester 102 may utilize a RFID tag, an electronic key, or an ID card with a magnetic strip on the access control device 122 to attempt to gain access to the one or more access controlled assets 120.

In some implementations, in response to the attempt to access by the requester 102, the access control device 122 may transmit an indication that the requester 102 is attempting access the one or more access controlled assets 120 to the server 140. The indication may include a personnel identification associated with the PIN, the password, the RFID, the electronic key, or the ID card. The personnel identification may include an alpha-numeric number associated with an owner of the PIN, the password, the RFID, the electronic key, or the ID card. The indication may include an asset identification that includes one or more alpha-numeric number associated with the one or more access controlled assets 120. The indication may include a time of request indicating the local time at the one or more access controlled assets 120 when the requester 102 attempted to access the one or more access controlled assets 120.

In some implementations, the owner may be the “rightful” possessor of the PIN, the password, the RFID, the electronic key, or the ID card. The owner may be the same person as the requester 102 in some instances. In other examples, the owner may be different from the requester 102 (e.g., the requester 102 took the ID card from the owner, the requester 102 obtained the password from the owner, or the requester 102 stole the electronic key from the owner).

In certain aspects, in response to receiving the indication, the server 140 may extract the personnel identification associated with the owner of the PIN, the password, the RFID, the electronic key, or the ID card. The server 140 may search for the owner using the personnel identification in the server 140 and/or the optional data repository 150. The server 140 may attempt to identify one or more of the name, employment number, customer number, contractor number, work group, business sector, organization, access rights and privileges, and/or other information to determine whether the owner is authorized to access the one or more access controlled assets 120.

In some aspects, the server 140 may determine that the owner is not authorized to access the one or more access controlled assets 120. The server 140 may withhold an access code. In some examples, the server 140 may transmit a rejection indication to the access control device 122 to alert the access control device 122 that the requester 102 does not have authority to access the one or more access controlled assets 120. In some implementations, the server 140 may transmit an alert indication to alert one or more predetermined party(ies) (e.g., manager(s) of the one or more access controlled assets 120, police, firefighter, sheriff, on-site security personnel, off-site security personnel).

In some non-limiting examples, the server 140 may determine that the owner is authorized to access the one or more access controlled assets 120. The server 140 may transmit the access code to the handheld device 104 via a text message, an electronic mail, or a security software. The security software may be a program installed on the handheld device 104 for safely receiving the access code from the server 140. If the handheld device 104 is in the possession of the requester 102 (e.g., owner of the PIN, the password, the RFID, the electronic key, or the ID card is the same person as the requester 102), then the requester 102 may receive the access code via the handheld device 104. After receiving the access code, the requester 102 may utilize the access code to access the one or more access controlled assets 120. However, if the handheld device 104 is not in the possession of the requester 102 (e.g., owner of the PIN, the password, the RFID, the electronic key, or the ID card is not the same person as the requester 102), the requester 102 will not receive the access code. Therefore, the requester 102 will not be able to access the one or more access controlled assets 120.

In some implementations, the access code may be generated randomly. Randomly generated access code may reduce the chance that an unauthorized person can guess the access code. Additionally or alternatively, the access code may have a short lifespan (e.g., 30 seconds, 1 minute, 2 minutes, 5 minutes, 10 minutes or other durations). The short lifespan may prevent the access code from being reused later or shared with unauthorized people. Other measures may also be utilized to increase security, such as encrypting the transmission of the access code.

In some implementations, the server 104 may log the authorized and/or unauthorized access including the information of the owner (e.g., employee ID, vendor ID, contractor ID, etc.), the request time, information relating to the access control device 122 (e.g., device physical/logical ID, media access control address, etc.), information relating to the one or more access controlled assets 120 (e.g., device physical/logical ID, media access control address, etc.), and/or whether the access request is authorized or unauthorized.

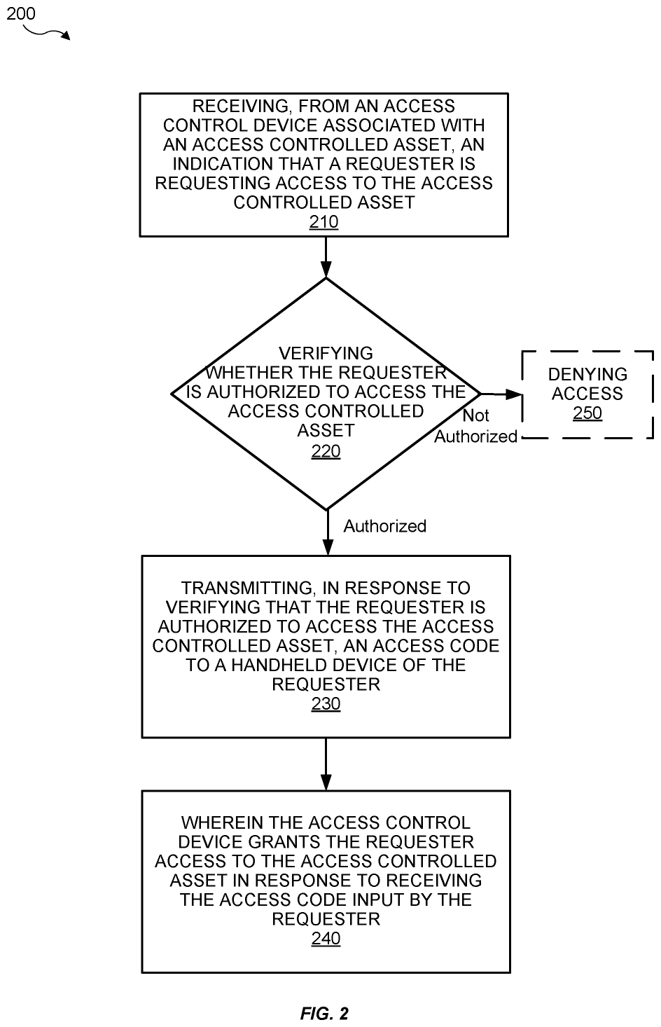

Turning now to FIG. 2, a method 200 for authenticating an access request may be performed by the server 140, the communication component 142, and/or the authentication component 144.

At block 210, the method 200 may receive, from an access control device associated with an access controlled asset, an indication that a requester is requesting access to the access controlled asset. For example, the communication component 142 of the server 140 may receive, from the access control device 122 associated with the one or more access controlled assets 120, an indication that the requester 102 is requesting access to the one or more access controlled assets 120.

At block 220, the method 200 may verify whether the requester is authorized to access the access controlled asset. For example, the authentication component 144 of the server 140 may verify whether the requester 102 is authorized to access the one or more access controlled assets 120.

At block 230, the method 200 may transmit, in response to verifying that the requester is authorized to access the access controlled asset, an access code to a handheld device of the requester. For example, the communication component 142 of the server 140 may transmit, in response to verifying that the requester 102 is authorized to access the one or more access controlled assets 120, an access code to the handheld device 104 of the requester 102.

At block 240, after the transmission of the access code, the access control device 122 may grant the requester 102 access to the one or more access controlled assets 120 in response to receiving the access code input by the requester 102.

At block 250, in an optional implementation, if the server 140 verifies that the requester is not authorized to access the access controlled asset or is unable to verify that the requester is authorized to access the access controlled asset, the server 140 may deny access to the requester. For example, if the authentication component 144 verifies that the requester 102 is not authorized to access the one or more access controlled assets 120 or is unable to verify that the requester is authorized to access the one or more access controlled assets 120, the communication component 142 of the server 140 may deny access by withholding the access code.

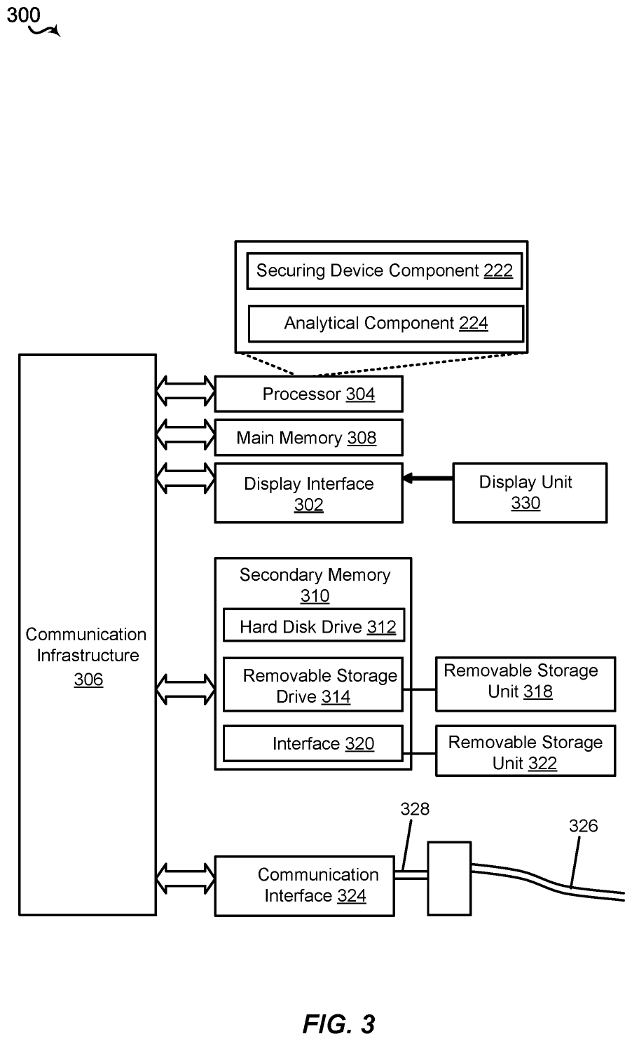

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 300 is shown in FIG. 3.

The computer system 300 includes one or more processors, such as processor 304. The processor 304 is connected with a communication infrastructure 306 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 300 may include a display interface 302 that forwards graphics, text, and other data from the communication infrastructure 306 (or from a frame buffer not shown) for display on a display unit 330. Computer system 300 also includes a main memory 308, preferably random access memory (RAM), and may also include a secondary memory 310. The secondary memory 310 may include, for example, a hard disk drive 312, and/or a removable storage drive 314, representing a floppy disk drive, a magnetic tape drive, an optical disk drive, a universal serial bus (USB) flash drive, etc. The removable storage drive 314 reads from and/or writes to a removable storage unit 318 in a well-known manner. Removable storage unit 318 represents a floppy disk, magnetic tape, optical disk, USB flash drive etc., which is read by and written to removable storage drive 314. As will be appreciated, the removable storage unit 318 includes a computer usable storage medium having stored therein computer software and/or data. In some examples, one or more of the main memory 308, the secondary memory 310, the removable storage unit 318, and/or the removable storage unit 322 may be a non-transitory memory.

Alternative aspects of the present disclosures may include secondary memory 310 and may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328, which may be electronic, electromagnetic, optical or other signals capable of being received by communications interface 324. These signals 328 are provided to communications interface 324 via a communications path (e.g., channel) 326. This path 326 carries signals 328 and may be implemented using wire or cable, fiber optics, a telephone line, a cellular link, an RF link and/or other communications channels. In this document, the terms “computer program medium” and “computer usable medium” are used to refer generally to media such as a removable storage drive 318, a hard disk installed in hard disk drive 312, and signals 328. These computer program products provide software to the computer system 300. Aspects of the present disclosures are directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features in accordance with aspects of the present disclosures, as discussed herein. In particular, the computer programs, when executed, enable the processor 304 to perform the features in accordance with aspects of the present disclosures. Accordingly, such computer programs represent controllers of the computer system 300.

In an aspect of the present disclosures where the method is implemented using software, the software may be stored in a computer program product and loaded into computer system 300 using removable storage drive 314, hard drive 312, or communications interface 320. The control logic (software), when executed by the processor 304, causes the processor 304 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

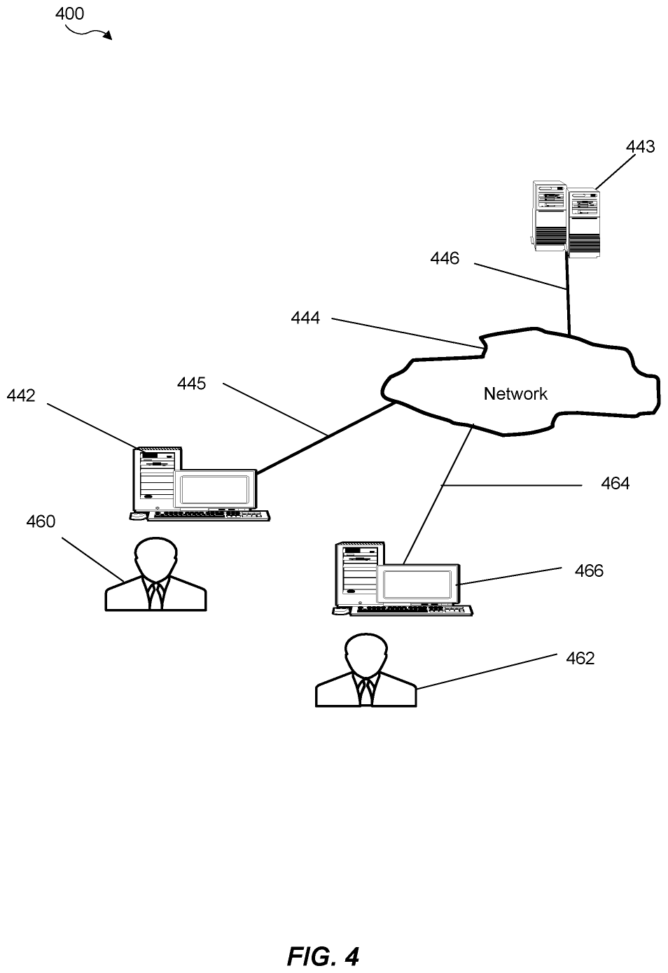

FIG. 4 is a block diagram of various example system components, in accordance with an aspect of the present disclosure. FIG. 8 shows a communication system 400 usable in accordance with the present disclosure. The communication system 400 includes one or more accessors 460, 462 (also referred to interchangeably herein as one or more “users”) and one or more terminals 442, 466. In one aspect, data for use in accordance with aspects of the present disclosure is, for example, input and/or accessed by accessors 460, 462 via terminals 442, 466, such as personal computers (PCs), minicomputers, mainframe computers, microcomputers, telephonic devices, or wireless devices, such as personal digital assistants (“PDAs”) or a hand-held wireless devices coupled to a server 443, such as a PC, minicomputer, mainframe computer, microcomputer, or other device having a processor and a repository for data and/or connection to a repository for data, via, for example, a network 444, such as the Internet or an intranet, and couplings 445, 446, 464. The couplings 445, 446, 464 include, for example, wired, wireless, or fiberoptic links. In another example variation, the method and system in accordance with aspects of the present disclosure operate in a stand-alone environment, such as on a single terminal.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of authenticating an access request, comprising:
receiving, from an access control device associated with an access controlled asset, an indication that a requester is requesting access to the access controlled asset;
verifying whether the requester is authorized to access the access controlled asset;
transmitting, in response to verifying that the requester is authorized to access the access controlled asset, an access code to a handheld device of the requester; and
wherein the access control device grants the requester access to the access controlled asset in response to receiving the access code input by the requester.

2. The method of claim 1, wherein the access controlled asset comprises a fire panel.

3. The method of claim 1, further comprises logging at least one of the access request, information relating to the requester, a time of the access request, or an identification associated with the access controlled asset.

4. The method of claim 1, wherein:
the access control device receives initial authentication information from the requester; and
the indication includes at least a portion of the initial authentication information identifying the requestor.

5. The method of claim 4, wherein the initial authentication information includes a personal identification number or a password.

6. The method of claim 1, wherein the access code is transmitted via a text message, an electronic mail, or a security software.

7. A server, comprising:
a memory,
one or more processors operatively connected to the memory, the one or more processors being configured to:
receive, from an access control device associated with an access controlled asset, an indication that a requester is requesting access to the access controlled asset;
verify whether the requester is authorized to access the access controlled asset;
transmit, in response to verifying that the requester is authorized to access the access controlled asset, an access code to a handheld device of the requester; and
wherein the access control device grants the requester access to the access controlled asset in response to receiving the access code input by the requester.

8. The server of claim 7, wherein the access controlled asset comprises a fire panel.

9. The server of claim 7, wherein the one or more processors is further configured to log at least one of the access request, information relating to the requester, a time of the access request, or an identification associated with the access controlled asset.

10. The server of claim 7, wherein:
the access control device receives initial authentication information from the requester; and
the indication includes at least a portion of the initial authentication information identifying the requestor.

11. The server of claim 10, wherein the initial authentication information includes a personal identification number or a password.

12. The server of claim 7, wherein the access code is transmitted via a text message, an electronic mail, or a security software.

13. A non-transitory computer readable medium having instructions stored therein that, when executed by one or more processors of a controller, cause the one or more processors to:
receive, from an access control device associated with an access controlled asset, an indication that a requester is requesting access to the access controlled asset;
verify whether the requester is authorized to access the access controlled asset;
transmit, in response to verifying that the requester is authorized to access the access controlled asset, an access code to a handheld device of the requester; and
wherein the access control device grants the requester access to the access controlled asset in response to receiving the access code input by the requester.

14. The non-transitory computer readable medium of claim 13, wherein the access controlled asset comprises a fire panel.

15. The non-transitory computer readable medium of claim 13, further comprises instructions that, when executed by the one or more processors, cause the one or more processors to log at least one of the access request, information relating to the requester, a time of the access request, or an identification associated with the access controlled asset.

16. The non-transitory computer readable medium of claim 13, wherein:
the access control device receives initial authentication information from the requester; and
the indication includes at least a portion of the initial authentication information identifying the requestor.

17. The non-transitory computer readable medium of claim 16, wherein the initial authentication information includes a personal identification number or a password.

18. The non-transitory computer readable medium of claim 13, wherein the access code is transmitted via a text message, an electronic mail, or a security software.
